(19) United States
(12) Patent Application Publication
(10) Pub. No.: US 2025/0265044 A1
(43) Pub. Date: Aug. 21, 2025

(54) CLOUD INFRASTRUCTURE CREATION AND MANAGEMENT SYSTEM

(71) Applicant: Brainboard, Inc., San Francisco, CA (US)

(72) Inventors: Chafik Belhaoues, New York, NY (US); Jeremy Albinet, New York, NY (US)

(21) Appl. No.: 18/581,308

(22) Filed: Feb. 19, 2024

(51) Int. Cl. G06F 8/34; G06F 8/10; G06F 8/33

(52) U.S. Cl. CPC G06F 8/34; G06F 8/10; G06F 8/33

(57) ABSTRACT

Systems, tools and methods to allow for the creation and management of any cloud infrastructure through an integrated development environment. The system generates resources and identity cards based on resources available for a service provider. The system provides a graphical development environment to select and place in a user interface the resources to create a system architecture. A user inputs information to a graphical representation of an identity card. Code is generated by the system relating to identity cards and resources selected for the system architecture.

### FIELD

The present invention relates generally to systems, tools and methods to allow for the creation and management of any cloud infrastructure through an integrated development environment.

### BACKGROUND

Designing and managing cloud architectures that use resources from third party providers traditionally is time consuming. Developers need to configure resources from many different providers when creating an architecture. Currently, a developer is required to handle cloud inheritance and dependencies manually.

### SUMMARY

The system and methods described herein provide for creating and managing cloud infrastructure. In some embodiments, the system may comprise a database, one or more service providers and a server. The server may be configured for generating a user interface comprising a resource panel, a design panel and a code panel; retrieving, from one or more providers, provider documentation and one or more provider schema; analyzing, for each provider, the provider documentation and one or more provider schema; identifying, based on the analysis, one or more resources from the one or more service providers; generating, based on the analysis, an identity card for each of the one or more resources wherein the identity card comprises one or more parameters; generating, based on the analysis, the resource panel wherein the resource panel comprises one or more resource icons, wherein the one or more resource icons correspond to the one or more resources; receiving, from the user, selection of a resource in the resource panel to be added to a design architecture displayed in the design panel and a placement of the resource within the design architecture; identifying the placement of the resource; displaying, in the user interface, the identity card corresponding to the added resource; receiving, from the user, input for each of the one or more identity card parameters, wherein the input comprises text values or selection of a displayed predefined value; generating code based on the design architecture and the identity card parameters corresponding to the resource; determining one or more affected resources in the design architecture affected by the addition of the resource; updating one or more affected identity card parameters of the one or more affected resources; and generating updated code for the one or more affected resources based at least in part on the one or more updated identity card parameters.

In some embodiments, the selection and placement of the resource within the design architecture may be performed by a drag and drop operation.

In some embodiments, the user interface may be a browser based application.

In some embodiments, analyzing the provider documentation and provider schema and identifying the one or more resources may be performed by a trained machine learning model.

In some embodiments, the trained machine learning model may be a large language model.

In some embodiments, the trained machine learning model may be a neural network.

In some embodiments, the system may further be configured to automatically populate one or more identity card parameters of the resource based on the identifying the placement of the resource.

In some embodiments, the resource panel may be organized into categories and sections.

In some embodiments, one or more of the resources may have more than one version and wherein an identity card may be generated for each version.

In some embodiments, the system may further be configured for receiving, from the user, a block of edited code and updating, based on the received block of edited code, the design architecture and identity card parameters of one or more linked resources.

The appended claims may also serve as a summary of this application.

The features and components of these embodiments will be described in further detail in the description which follows. Additional features and advantages will also be set forth in the description which follows, and in part will be implicit from the description, or may be learned by the practice of the embodiments. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary environment in which some embodiments may operate.

FIG. 2A is a diagram illustrating an exemplary client device in accordance with aspects of the present disclosure.

FIG. 2B is a diagram illustrating an exemplary server in accordance with aspects of the present disclosure.

FIG. 3A is a diagram illustrating an exemplary user interface in accordance with some embodiments.

FIG. 3B is a diagram illustrating an exemplary user interface in accordance with some embodiments.

FIG. 3C is a diagram illustrating an exemplary user interface in accordance with some embodiments.

FIG. 3D is a diagram illustrating an exemplary user interface in accordance with some embodiments.

FIG. 3E is a diagram illustrating an exemplary user interface in accordance with some embodiments.

FIG. 3F is a diagram illustrating an exemplary user interface in accordance with some embodiments.

FIG. 3G is a diagram illustrating an exemplary user interface in accordance with some embodiments.

FIG. 3H is a flow chart illustrating an exemplary method that may be performed in accordance with some embodiments.

FIG. 3I is a diagram illustrating an exemplary identity card in accordance with some embodiments.

FIG. 4 is a flow chart illustrating an exemplary method that may be performed in accordance with some embodiments.

FIG. 5 is a flow chart illustrating an exemplary method that may be performed in accordance with some embodiments.

FIG. 6 is a diagram illustrating an exemplary computer/control system that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system, platform and methods for designing and managing cloud infrastructures. The terms architecture, infrastructure, software and framework may be used interchangeably in the following description of the invention.

In some embodiments, the system may use one or more resource machine learning models to analyze provider schema and documentation. The resource machine learning models may be trained on provider schema and documentation from previous versions of the provider infrastructure/software and/or schema and documentation from other providers. The schema and documentation from other providers may correspond to both current and previous versions of their infrastructure/software. The resource machine learning models may be used to identify resources and generated resource objects that may then be displayed to a user/developer for selection and insertion into a design architecture. The resource machine learning model may also be configured to identify one or more parameters for a resource, identify a type associated with the one or more parameters and make suggestions corresponding to parameter values for the one or more identified parameters.

In some embodiments, one or more design machine learning models may be trained on one or more design training datasets comprising previously designed architectures and configurations. The previously designed architectures and configurations may be architectures and configurations that have been identified and labeled as being accurate architectures. The identification and labeling may be based on one or more validation and/or verification processes. These design training datasets may be collected from code repositories such as GIT, or other versioning software systems. They may also be collected from proprietary and open source development frameworks.

In some embodiments, the system may be configured to make suggestions corresponding to ID Cards for resources based on the one or more resource machine learning models and the one or more design machine learning models. In some embodiments, the one or more resource machine learning models and/or the one or more design machine learning models may further be configured to determine all the possibilities (i.e., parameter values) that exist for one or more specific parameters/fields of each ID Card. The determined possibilities may then be provided to the user during configuration of each of the ID cards.

In some embodiments, the one or more of the resource machine learning models and/or one or more of the design machine learning models may be large language models (LLMs).

In some embodiments, in response to a drag and drop operation performed on a resource, the system may use the one or more design machine learning models to predict additional resources that a user may wish to add to the design architecture. The predicted additional resource may then be suggested to the user and/or automatically inserted into the design architecture. The predicted resources inserted into the design architecture may also be automatically configured based on analysis by the one or more design machine learning models. In some embodiments, the design machine learning models may provide the user with one or more parameter value suggestions, and the user may choose to accept the suggestions or provide their own parameter values to complete the configuration.

In some embodiments, the system may be configured to provide the user with an input prompt, wherein the input prompt may be associated with one or more of the one or more design machine learning models. In some embodiments, the input prompt may be associated with an LLM. The user may enter a written description of an architecture/infrastructure that they wish to create and the LLM may then generate one or more candidate designs based on the description. These candidate designs may then be provided to the user for selection and/or further modification. Additional input from the user in the input prompt may be used to further modify a selected candidate design. The system may further be configured to eliminate hallucinations in the generated candidate designs by restricting resource choices and design configurations in the generated designs to those that are verifiable, supportable and provable. In some embodiments, the one or more generated candidate designs may be analyzed to determine if the design choices (resources and configurations) meet one or more formal requirements, test cases and/or use cases. The system may be configured to identify the sources of the decisions made by the LLM in the generation of the candidate designs and determine if the sources are 100% verifiably true.

In some embodiments, the system may use the LLM to sort all the parameters for an ID card based on their use in accurate architectures and/or existing systems. The LLM may then select a set of parameters to display to the user based on one or more relevance factors. In some embodiments, the selection of the set of parameters may be based on a frequency of use of the parameters. For example, the LLM may select all parameters which have a frequency of use above a predetermined threshold, such as 90%. The user may then be shown a list with all parameters that are used in 90% or more of the accurate architectures.

In some embodiments, the LLM may be used in the generation of a first version of the infrastructure, allowing for the faster and easier creation of the infrastructure by the user.

In some embodiments, the LLM may be used to analyze and/or improve a design infrastructure that has been generated or modified by the user. The system may generate a token that corresponds to the complete architecture of the infrastructure. This token may then be provided to the LLM, and the LLM may then generate an answer based on the context of the provided token.

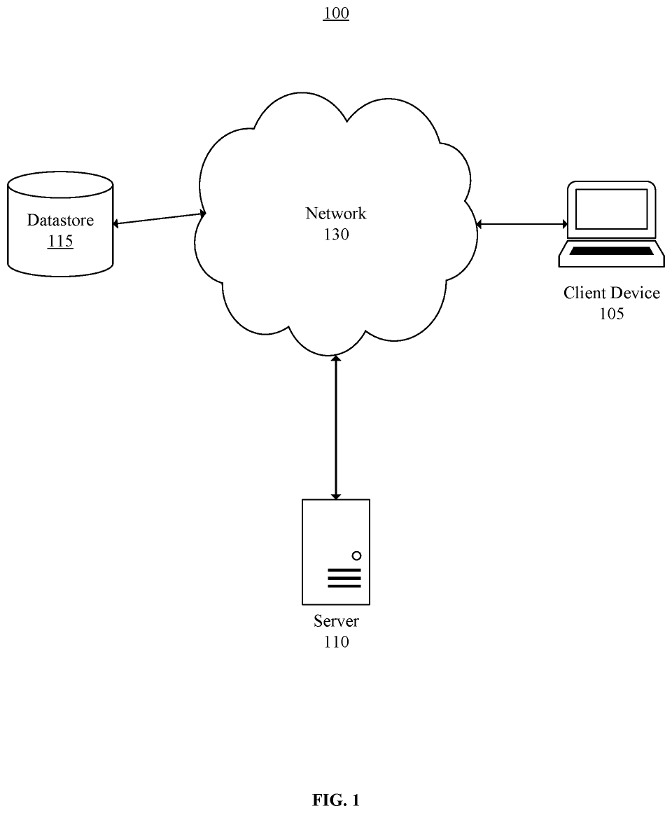

FIG. 1 is a diagram illustrating an exemplary a cloud architecture development system 100 in which some embodiments may operate. The cloud architecture development system 100 may comprise one or more client devices 105, one or more servers 110, one or more datastores 115 and one or more networks 130.

The client devices 105 may be any computing device capable of communicating over network 130. The client devices 105 may be integrated into a notebook computer, smartphone, personal digital assistant, desktop computer, tablet computer, or other computing device.

Server 110 may be one or more physical or virtual machines configured to communicate with the one or more client devices 105 and the one or more datastores 115. The one or more servers 110 may be configured as a distributed computing infrastructure and processing of applications and other software may be carried out on the cloud.

Datastores 115 may communicate with one another over network 130. Datastores 115 may be any storage device capable of storing data for processing or as a result of processing information at the client devices 105 and/or servers 110. The datastores 115 may be a separate device or the same device as server 110. The datastores 115 may be located in the same location as that of server 110, or at separate locations.

Network 130 may be an intranet, internet, mesh, LTE, GSM, peer-to-peer or other communication network that allows the one or more servers 110 to communicate with the one or more client devices 105 and datastores 115.

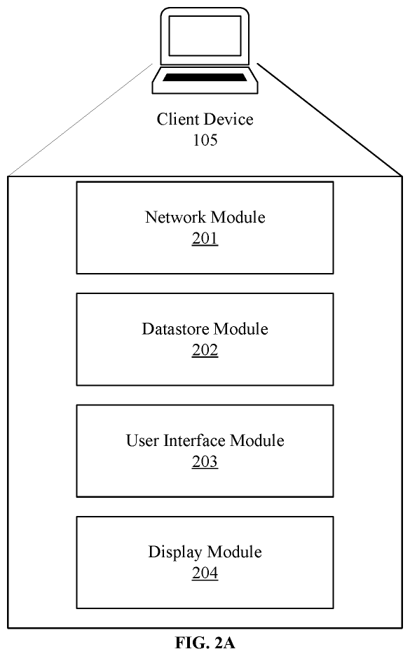

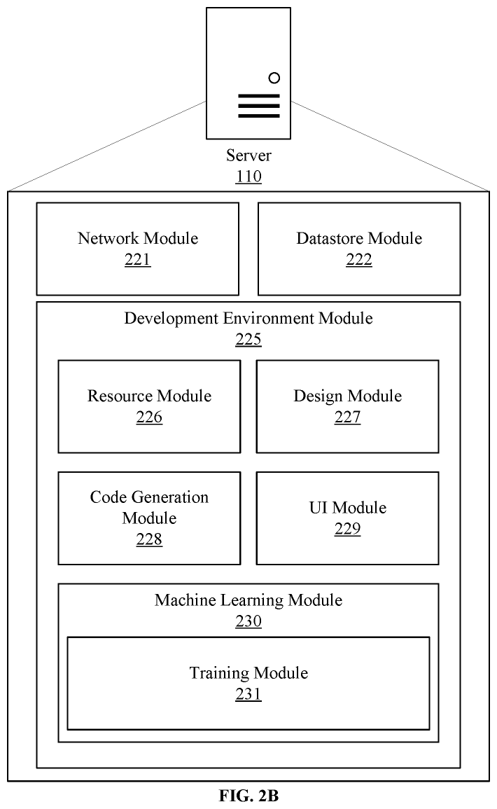

FIG. 2A is a diagram illustrating an exemplary client device 105 in accordance with aspects of the present disclosure. Client device 105 may comprise network module 201, datastore module 202, user interface module 203 and display module 204.

Network module 201 may transmit and receive data from other computing systems via a network. In some embodiments, the network module 201 may enable transmitting and receiving data from the Internet. Data received by the network module 201 may be used by the other modules. The modules may transmit data through the network module 201.

The datastore module 202 may be configured to store information generated by the one or more modules operating on the client device 105. The one or more modules operating on the client device 105 may also retrieve information from the datastore module 202.

User interface module 203 may generate a user interface (UI) based on information received from server 110. The user interface module 203 may further manage user interactions with the UI and the updating of the UI based at least in part on the user interactions. The UI may comprise one or more interfaces and/or elements of the one or more interfaces. The one or more interfaces may include panels, windows, tabs, containers and/or combination thereof. The one or more interfaces may be any structure or object that organizes and/or displays information graphically. In some embodiments, the user interface module 203 may be configured to manage a UI generated remotely on server 110. The managing may comprise receiving user interactions with the UI, processing the user interactions, updating the UI based on the user interactions and/or information received from server 110, transmit the user interactions to the server 110 and transmitting information associated with the user interface module 203 processing the user interactions.

Display module 204 may be any device configured to display graphical representations of information (LCD display, OLED display, DLP display, etc.). Display module 204 may be further configured to display graphical representations of the UI generated or received by the user interface module 203. Display module 204 may further be configured to display interactions of the user with the UI.

FIG. 2B is a diagram illustrating an exemplary server 110 in accordance with aspects of the present disclosure. Server 110 may comprise network module 221, datastore module 222 and development environment module 225.

Network module 221, may be the same or similar to that of network module 201 in FIG. 2A and will not be described for the sake of brevity.

Datastore module 222 may be configured to store an imported provider schema, imported provider documentation and data generated through analyzing the imported provider schema and imported provider documentation.

Development environment module 225 may comprise resource module 226, design module 227, code generation module 228, UI module 229 and machine learning module 230.

Resource module 226 may be configured to analyze documentation corresponding to one or more services or service providers. In some embodiments, the documentation may include schema of a corresponding service. In some embodiments, the documentation may include application programming interface (API) documentation, user manuals, instruction manuals, reference manuals, training materials, installation guides, hardware documentation, software documentation, technical design documents, project plans, project requirements specifications, process documentation, development plans, testing plans, release plans, bug tracking reports, data model documentation, architecture documentation, release notes, troubleshooting documentation, reference documents, explanations, forum posts or combination thereof. Resource module 226 may be configured to identify one or more resources based on analysis of documentation from one or more providers. The resource module 226 may further be configured to identify parameters associated with the identified resources based on the analysis of the documentation. Resource module 226 may further identify and retrieve icons associated with each of the identified sources.

Design module 227 may be configured to display a graphical representation of a design architecture. The organization or resources and relationships between resources may be displayed dynamically. User interaction with resources in the design module may result in changes to identity card parameters and other configuration information relating to the resources displayed.

Code generation module 228 may be configured to generate code based on the design architecture and configuration of resources and their associated identity cards. Code may also be generated during interactive modification, by the user, to the design architecture and resource configurations.

UI module 229 may be configured to manage input and output corresponding to the user interface.

Machine learning module 230 may further comprise training module 231 and analysis module 232. Machine learning module 230 may be configured to generate one or more machine learning models. The one or more machine learning models may be used to analyze provider schema and provider documentation. The analysis performed by the one or more machine learning models may be used by the resource module in the populating of the resource panel with resources. In some embodiments, the one or more machine learning models may be used in the generation of code and the organization of the resources in the architectural design.

In some embodiments, the training module 231 may be configured to train a language learning model (LLM), neural network or other machine learning models. Training may be performed to generate a new model or update a previously generated model. In some embodiments, the training module may receive an updated training set for retraining after the initial training of the model is performed.

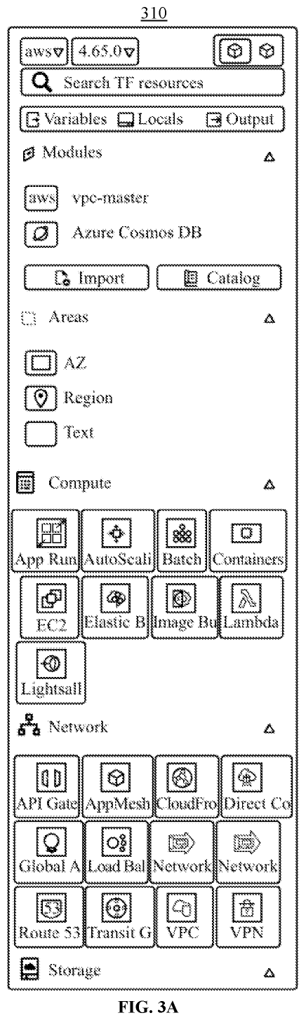

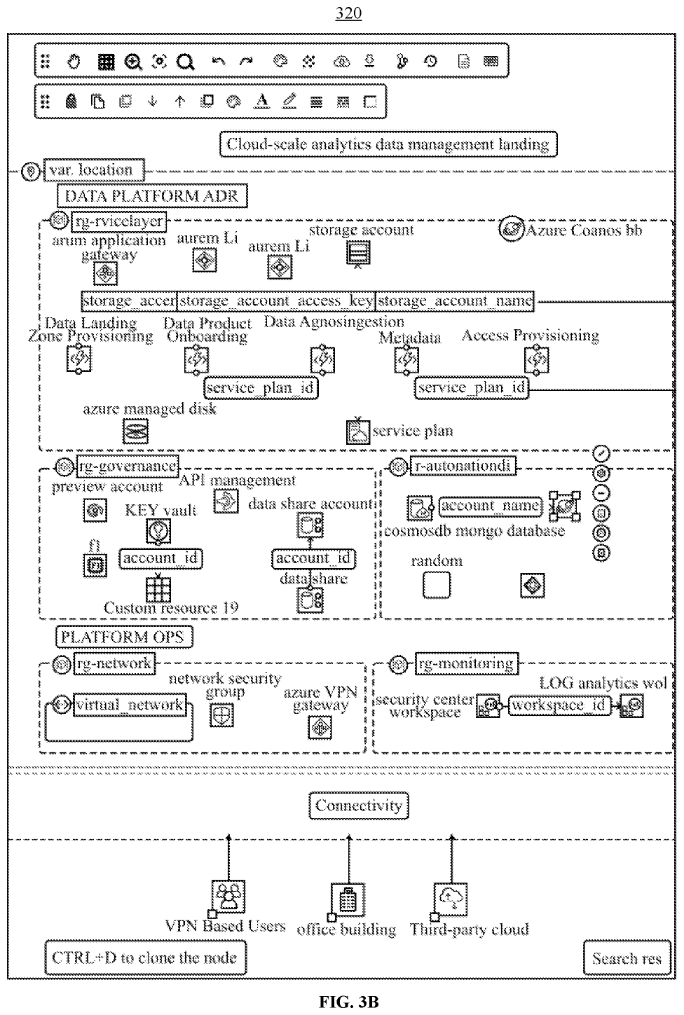

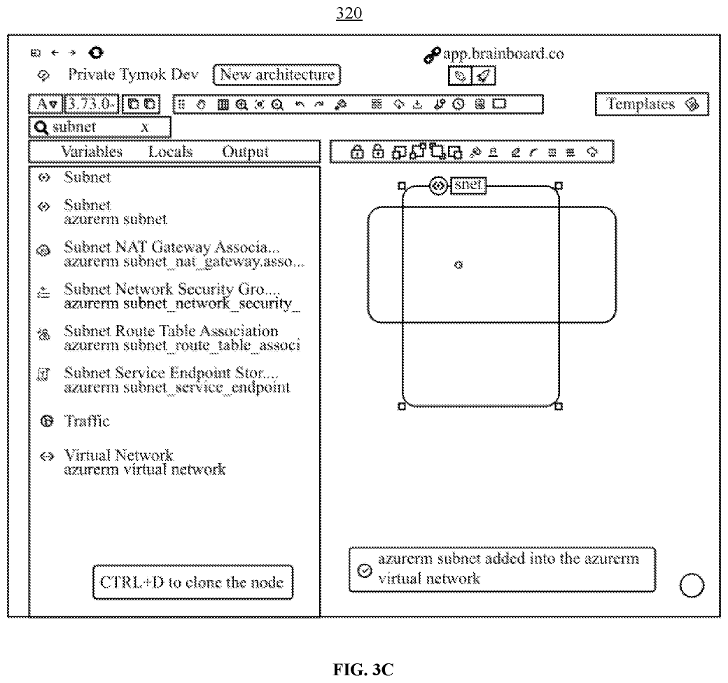

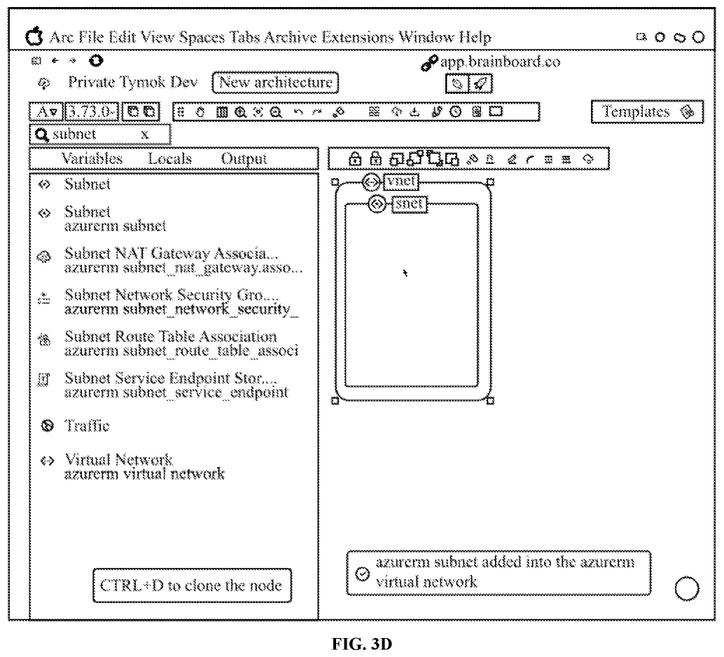

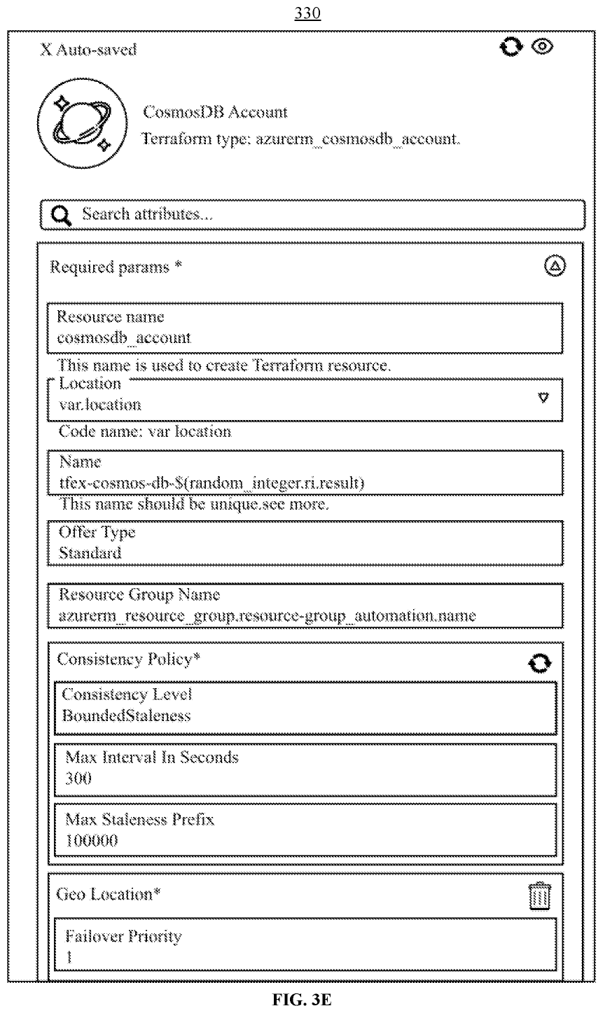

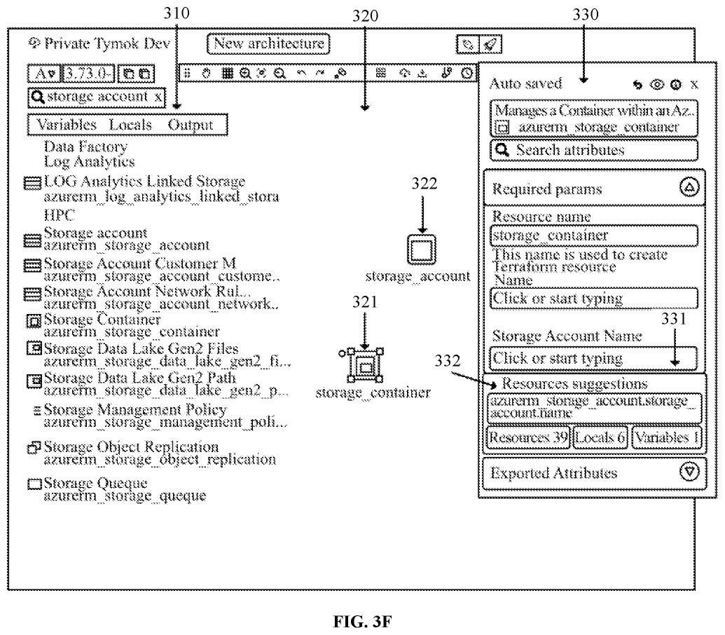

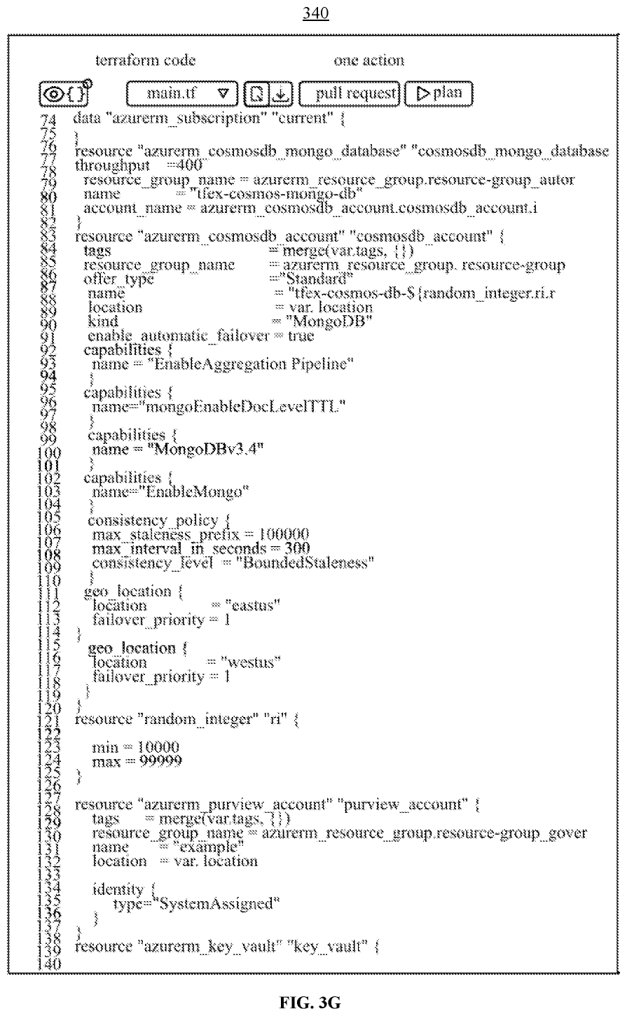

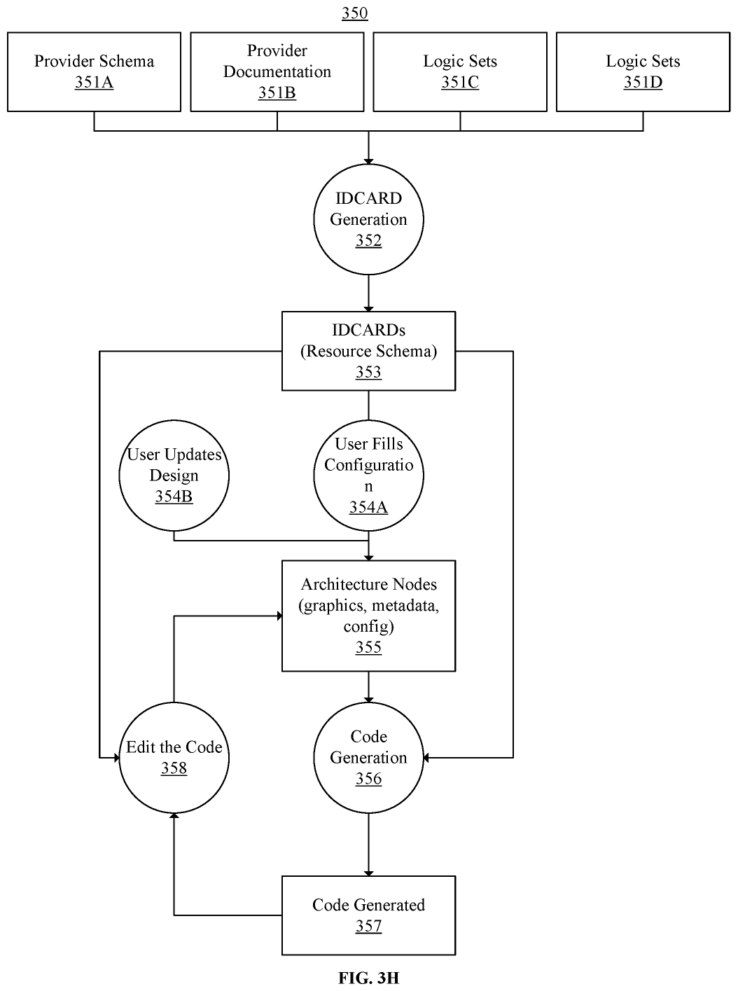

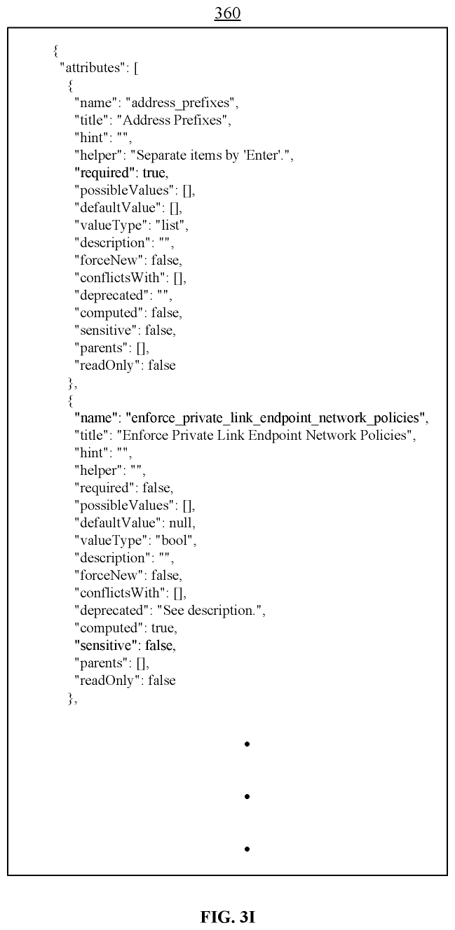

FIG. 3A is a diagram illustrating an exemplary resource panel 310 in accordance with some embodiments. The resource panel 310 may be configured to display one or more resources from one or more providers, wherein the resources are graphically represented by icons. The resource panel 310 may be populated with resources in an automated manner. Provider schema and provider documentation for one or more providers may be analyzed to identify one or more resources. The identified resources may then be displayed in the resources panel 310. A user may select one or more of the resources from the resource panel 310 to be placed in a design panel (FIG. 3B 320). The selection and adding may be performed by a drag and drop operation. In some embodiments, other selection and addition techniques may be used to perform the operation.

FIG. 3B is a diagram illustrating an exemplary design panel 320 in accordance with some embodiments. The design panel 320 may be configured to graphically represent one or more resources and their relationships and interconnections with one another. The design panel 320 may allow for direct user interaction with displayed resources. The direct interaction may include repositioning, reorganizing, changing/removing/adding relationships and interconnections between resources, grouping of resources or combination thereof.

FIGS. 3C-D are diagrams illustrating an exemplary design panel 320 in accordance with some embodiments. FIG. 3C shows an example where a user is attempting to add a subnet resource and a virtual network resource to the design panel 320. As shown in FIG. 3C, a user may attempt to add a virtual network to a subnet. The system may be configured to determine if a resource may be nested or otherwise contained within another resource based on analysis of the respective resources. In this example, the system may determine that a virtual network may not be placed within a subnet and as a result system may attempt to identify an acceptable positioning and correspondence between the two resources. For example, the system may assign hierarchy levels to each resource, and based on the hierarchy levels, nest the resources correctly. The hierarchy of the resources may be used to identify possibly parent/child relationships. In some embodiments, the hierarchy may be used to automatically position resources within the design panel in relation to other resources. As can be seen in FIG. 3D, the system reorganizes the subnet within the virtual network based upon a hierarchy level of the two resources.

In some embodiments, overlapping resources in the design panel may result in the reorganization of the resources based on their hierarchy level. In some embodiments, the hierarchy level may be modified by the user.

FIG. 3E is a diagram illustrating an exemplary identity card 330 in accordance with some embodiments. The identity card 330 may correspond to a resource being added to the design panel 320 or to a resource in the design panel 320 being update/modified. The identity card 330 may comprise one or more parameters, wherein the parameters may be required, optional or combination thereof. The user may input values into the one or more parameters to configure the operation or properties of the associated resource. Setting parameter values in the identity card 330 of a resource may result in the updating/modifying of properties of other resources that inherit properties/parameters from the resource associated with the identity card. In some embodiments, resources that have dependencies associated with the identity card parameter being set may also be updated/modified based on the setting of the parameter values.

FIG. 3F is a diagram illustrating an exemplary design panel 320 and identity card 330 in accordance with some embodiments.

For example, a user may select, from resource panel 310, a storage container and storage account to be added to the design panel. As shown in FIG. 3F, a storage container 321 and a storage account 322 have been added to the design panel 320. In this example, the system may be configured to identify that storage container 321 may be associated with storage account 322. An identity card 330 associated with the storage container 321 may be displayed to the user upon selection of the storage container icon by the user. In some embodiments, the identity card 330 may be automatically displayed to the user upon the addition of the storage container 321 to the design panel 320. In some embodiments, the identity card 330 for the storage container 321 after detection of the addition of the storage account 322. In some embodiments, the displaying of identity cards corresponding to resources in the design panel 320 may be based on user selection, updates to the resources in the design panel, additions of resources to the design panel, modification of code corresponding to resources in the design panel, modification of identity cards corresponding to related resources or combination thereof. In some embodiments, directional relationships may be used to determine a type of correspondence between resources. A hierarchy may be used in the determination of relationships between resources.

In some embodiments, the system may be configured to determine that there is a resource in the design panel that matches a specific field in the identity card 330. For example, the identity card 330 has a storage account name field 331. The system may identify the storage account 322 as a possible match for the storage account name field 331 and display the resource as a suggestion for the user to select. In some embodiments, suggestions may be displayed in a suggestion prompt 332. A selection of the suggestion by the user may then generate an association between the two resources and code may then be generated corresponding to the association.

In some embodiments, the system may be configured to generate one or more suggestions for each field of the identity card 330. In some embodiments, each field may have one or more static suggestions, one or more dynamic suggestions, one or more AI (machine learning) generated suggestions or combination thereof. In some embodiments, the static, dynamic and AI generated suggestions may be displayed together, without any differentiation of how the suggestion was generated. In some embodiments, an indication as to the suggestion generation method may be displayed to the user. In some embodiments, the suggestions may be listed in groupings by type. In some embodiments, AI generated suggestions for one or more identity card fields may be generated ahead of time. In some embodiments, the AI generation of suggestions for identity card fields may be generated based on provider schema and documentation at the time of scraping and adding the resource to the resource panel. In some embodiments, the AI generated suggestions may be generated upon addition of a resource to the design panel, but before selection of the identity card field. In some embodiments, the AI generated suggestion may be upon selection of the identity card field. In some embodiments, the AI generated suggestion may be generated more than once and at more than one time. For example, AI suggestions for an identity card field corresponding to an identity card of a resource may be generated when the resource is added to the resource panel, and then again at a later time when a user adds the resource to a design panel. The AI suggestions may be updated again after changes to the resource or other resources in the design panel, or additions/removals of resources from the design panel. When the user selects a field of the identity card, the system may be configured to determine if the AI generated suggestions need to be updated or if the current suggestions should be displayed to the user. In some embodiments, if modifications to the design have been made, the system may determine that a new set of suggestions or modification to the current AI generated suggestions is needed, and therefore generated after selection of the field by the user.

In some embodiments, the generating of AI suggestions may comprise, identifying each resource for a provider based on the provider schema and documentation. For each of the identified resources the system may be configured to identify each parameter/field associated with the resource. Each of the resources and parameters/fields may be provided to a machine learning model for analysis and identification of possible values corresponding to each of the parameters/fields. In some embodiments, the resources, parameters, provider schema and documentation and third party information may be provided to the machine learning model as a prompt. In some embodiments, the machine learning model is a large language model (LLM).

In some embodiments, the machine learning model may be configured to identify unused or unassociated resources in the design panel and determine if a possible correspondence between the identified resources and other resources in the design panel exists. In some embodiments, the machine learning model may be configured to analyze the identified unused/unassociated resources when generating suggestions for the identity card fields.

FIG. 3G is a diagram illustrating an exemplary code panel 340 in accordance with some embodiments. The code panel 340 may be configured to display one or more blocks of generated code corresponding to the resources being displayed in the design panel 320. In some embodiments, the code shown in the code panel 340 may correspond to a resource selected in the design panel 320.

FIG. 3H is a flow chart illustrating an exemplary method 350 that may be performed in accordance with some embodiments.

At step 351A, the system may retrieve one or more provider schema from one or more providers.

At step 351B, the system may retrieve provider documentation from the one or more providers. In some embodiments, the documentation may include (API) documentation, user manuals, instruction manuals, reference manuals, training materials, installation guides, hardware documentation, software documentation, technical design documents, project plans, project requirements specifications, process documentation, development plans, testing plans, release plans, bug tracking reports, data model documentation, architecture documentation, release notes, troubleshooting documentation, reference documents, explanations, forum posts or combination thereof.

At step 351C, the system may load one or more sets of logic. The one or more sets of logic may comprise trained machine learning models configured to identify and extract resources from provider schema and provider documentation. The machine learning models may further be configured to identify and extract parameters corresponding to the said resources.

At step 351D, the system may load smart suggestions generated for the resource. The smart suggestions may be AI (machine learning) generated suggestions.

At step 352, the system may be configured to generate IDCARDs for one or more resources based on analyzing provider schema from step 351A and provider documentation from 351B, wherein the analyzing is performed by the logic received from step 351C. The IDCARDs may comprise configuration parameters, wherein one or more of the configuration parameters may be required parameters. In some embodiments, the parameters that are identified as being required may be displayed/positioned at the top of the list of parameters. Parameters determined to be non-required may be positioned after all the required parameters.

At step 353, the system may be configured to generate a resource schema for the one or more generated IDCARDs.

At step 354A, the system may be configured to receive user input for one or more resources through a user interface. The user input may correspond to IDCARD configuration parameters of the one or more resources. The user may be allowed to enter text values or select predetermined values for one or more parameters.

At step 354B, the system may receive one or more user updates, wherein the one or more user updates correspond to one or more design elements or architecture nodes. The design elements and architecture nodes may correspond to interfaces or interface elements.

At step 355, the system may be configured to create and/or update architecture nodes or design elements, based on the user input from step 354A and/or user updates received from step 354B. The architecture nodes and design elements may be organized and displayed in a design panel representing the relationships and interactions between resources. Changes to the graphical representations of resources, their relationship to one another and the configuration information corresponding to the displayed resources may be based directly or indirectly on the received user input/updates. In some embodiments, updating of one resource may cause the creation or modification of one or more other resources. The system may also generate or update metadata associated with the resource, the IDCARD of the resource, graphical representations of the resource or combination thereof.

At step 356, the system may be configured to generate code based on the resources and relationships between the resources displayed in the design panel. In some embodiments, the creating and/or updating of architecture nodes or design elements may result in the generation of one or more blocks of code. In some embodiments, updating architecture nodes or design elements may result in the modification of previously generated code, wherein the modification comprises adding, removing and/or updating resource parameters associated with the updating.

At step 357, the system may be configured to incorporate the generated code from step 356 into a larger code block. The system may then display the generated code in a code panel.

At step 358, the user may edit the code directly in the code panel. The direct editing of code by the user may trigger the creation and/or updating of architecture nodes or design elements in the design panel and/or changes to their organization. The direct editing of code may result in the modification of the relationships and interconnections between the resources displayed in the design panel. In some embodiments, the generated code may not be stored or otherwise retained. Data corresponding to identity cards and the design elements in the design architecture may be stored and used to generate code dynamically. The generated code may at least partially be based on coordinate positions of design elements in the design architecture and their relation to one another.

FIG. 3I is a diagram illustrating an exemplary identity card object 360 in accordance with some embodiments. In some embodiments, the identity car object 360 may be a stored as a JSON object, plain text, or any other structured or unstructured data type.

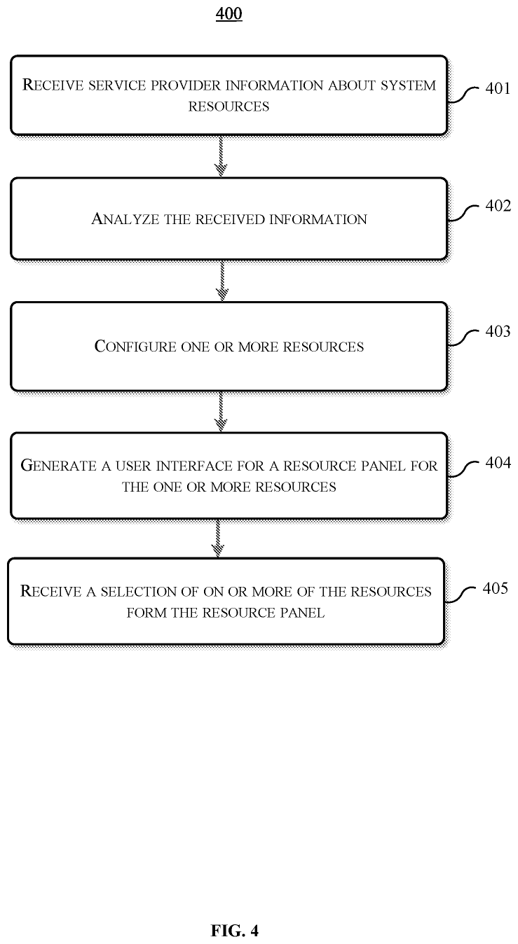

FIG. 4 is a flow chart illustrating an exemplary method 400 that may be performed in accordance with some embodiments.

At step 401, the system is configured to receive service provider information about system resources. The provider information may be retrieved from one or more service providers. The system resources may comprise provider documentation and provider schema. In some embodiments, the provider documentation and provider schema may be retrieved from a remote system and stored locally on the server 110 or in the datastore 115.

At step 402, the system is configured to analyze the received information. The analysis may be performed for each provider. In some embodiments, the analysis may include separating one or more resources identified in the schema into non-exported blocks and exported blocks and identifying metadate associated with those blocks. The analysis may also be configured to extract information for each source from the provider documentation. The extracted information may include category, description, title, possible values and conflicts.

At step 403, the system configures one or more resources. The one or more resources may be identified based on the analysis at step 402.

At step 404, the system is configured to generate a user interface for a resource panel for the one or more resources. The generation of the resource panel may be based at least in part on the analysis at step 402. The resource panel may further comprise one or more resource icons, wherein the one or more resource icons correspond to the one or more resources.

At step 405, the system is configured to receive a selection of one or more resources from the resource panel. The user may place the one or more resources into a design region of the user interface. The selection and placement may be performed with a drag and drop operation.

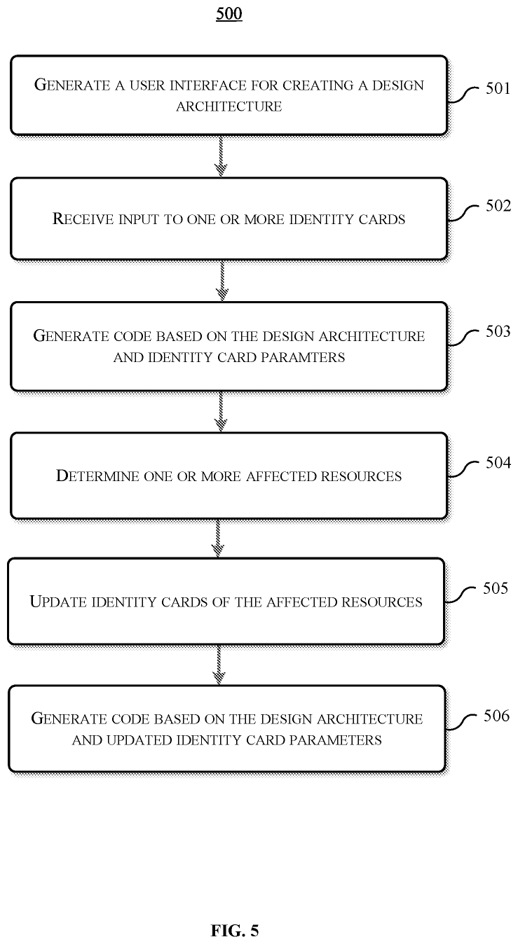

FIG. 5 is a flow chart illustrating an exemplary method 500 that may be performed in accordance with some embodiments.

At step 501, the system is configured to generate a user interface for creating a design architecture. The user interface may comprise a resource panel, a design panel and a code panel.

At step 502, the system is configured to receive, from the user, input for one or more identity cards. The input may be for each of one or more identity card parameters, wherein the input comprises text values or selection of a displayed predefined value. In some embodiments, some or all of the parameter values may be stored as string values. The type of data corresponding to each parameter may be determined in real-time and the string value for each parameter may be converted to the determined type before generation of code. In some embodiments, the identity card may have its parameters checked against expected values and data types before generation of code.

At step 503, the system is configured to generate code based on the design architecture and the identity card parameters corresponding to the resource.

At step 504, the system is configured to determine one or more affected resources in the design architecture affected by the addition of the resource.

At step 505, the system is configured to update one or more affected identity card parameters of the one or more affected resources.

At step 506, the system is configured to generate code based on the design architecture and updated identify card parameters.

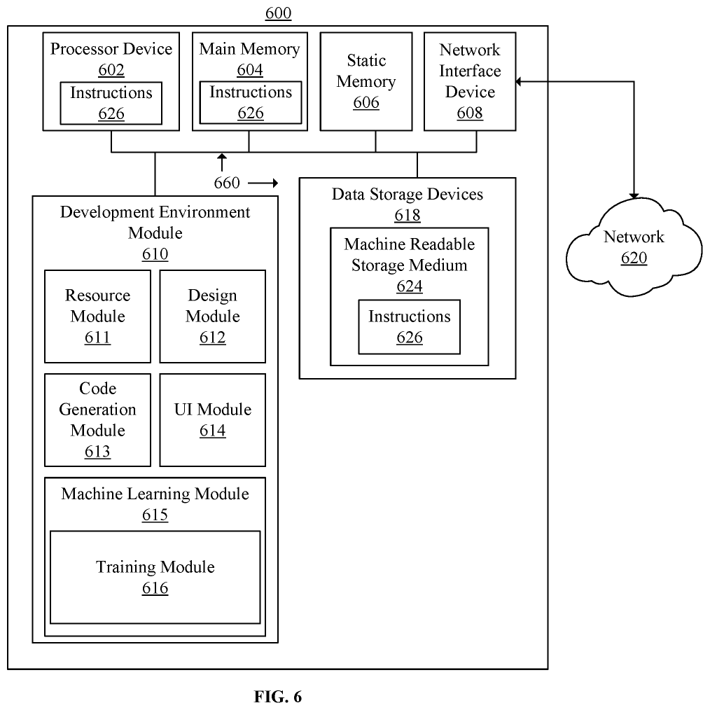

FIG. 6 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 660.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computer system 600 may further include a network interface device 608 to communicate over the network 620. The computer system 600 also may include development environment module 610. Development environment module 610 may further comprise resource module 611, design module 612, code generation module 613, UI module 614 and machine learning module 615. Machine learning module 615 may further comprise training module 616. Development environment module 610, resource module 611, design module 612, code generation module 613, UI module 614, machine learning module 615 and training module 616 may be the same or similar to that of development environment module 225, resource module 226, design module 227, code generation module 228, UI module 229, machine learning module 230 and training module 231 as disclosed in FIG. 2B.

The data storage device 618 may include a machine-readable storage medium 624 (also known as a computer-readable medium) on which is stored one or more sets of instructions or software 626 embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media. Information, including data used in the processes and methods of the system and the one or more sets of instructions or software, may also be stored in blockchain, as NFTs or other decentralized technologies.

In one implementation, the instructions 626 include instructions to implement functionality corresponding to the components of a device to perform the disclosure herein. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

It will be appreciated that the present disclosure may include any one and up to all of the following examples.

Example 1. An infrastructure as code system for creating and managing cloud infrastructure, wherein the system comprising: A server, wherein the server is configured for: Retrieving, from one or more providers, provider documentation and one or more provider schema; Analyzing, for each provider, the provider documentation and one or more provider schema; Identifying, based on the analysis, one or more resources from the one or more service providers; Generating, based on the analysis, an identity card for each of the one or more resources wherein the identity card comprises one or more parameters; Generating, based on the analysis, the resource panel wherein the resource panel comprises one or more resource icons, wherein the one or more resource icons correspond to the one or more resources; Receiving, from the user, selection of a resource in the resource panel to be added to a design architecture displayed in the design panel and a placement of the resource within the design architecture; Identifying the placement of the resource; Displaying, in the user interface, the identity card corresponding to the added resource;

Example 2. The system of Example 1, wherein the one or more processors further configured to perform the operations of: Generating a user interface comprising a resource panel, a design panel and a code panel; Receiving, from the user, input for each of the one or more identity card parameters, wherein the input comprises text values or selection of a displayed predefined value; Generating code based on the design architecture and the identity card parameters corresponding to the resource; Determining one or more affected resources in the design architecture affected by the addition of the resource; Updating one or more affected identity card parameters of the one or more affected resources; and Generating updated code for the one or more affected resources based at least in part on the one or more updated identity card parameters.

Example 3. The system of Example 2, wherein the selection and placement of the resource within the design architecture is performed by a drag and drop operation.

Example 4. The system of any one of Examples 1-3, wherein the user interface is a browser-based application.

Example 5. The system of any one of Examples 1-4, wherein the user interface is a standalone application running on a client device.

Example 6. The system of any one of Examples 1-5, wherein analyzing the provider documentation and provider schema and identifying the one or more resources are performed by a trained machine learning model.

Example 7. The system of any one of Examples 1-6, wherein the trained machine learning model is a large language model.

Example 8. The system of any one of Examples 1-7, wherein the trained machine learning model is a neural network.

Example 9. The system of any one of Examples 1-8, wherein the system is further configured to automatically populate one or more identity card parameters of the resource based at least in part on the identifying the placement of the resource.

Example 10. The system of any one of Examples 1-9, wherein automatically populating the one or more identity card parameters is further based at least in part on analysis by a second trained machine learning model, wherein the second trained machine learning model is trained on a dataset comprising one or more historic design architectures.

Example 11. The system of any one of Examples 1-10, wherein the resource panel is organized into categories and sections.

Example 12. The system of any one of Examples 1-11, wherein one or more of the resources has more than one version and wherein an identity card is generated for each version.

Example 13. The system of any one of Examples 1-12, wherein the system is further configured for: receiving, from the user, a block of edited code; and updating, based on the received block of edited code, the design architecture and identity card parameters of one or more linked resources.

Example 14. A computer-implemented method comprising: generating a user interface comprising a resource panel, a design panel and a code panel; retrieving, from one or more service providers, provider documentation and one or more provider schema; analyzing, for each provider, the provider documentation and one or more provider schema; identifying, based on the analysis, one or more resources from the one or more service providers; generating, based on the analysis, an identity card for each of the one or more resources wherein the identity card comprises one or more parameters; and generating, based on the analysis, the resource panel wherein the resource panel comprises one or more resource icons, wherein the one or more resource icons correspond to the one or more resources.

Example 15. The method of Example 14, wherein the one or more processors are further configured to perform the operations of: receiving, from a user, selection of a resource in the resource panel to be added to a design architecture displayed in the design panel and a placement of the resource within the design architecture; identifying the placement of the resource; displaying, in the user interface, the identity card corresponding to the added resource; receiving, from the user, input for each of the one or more identity card parameters, wherein the input comprises text values or selection of a displayed predefined value; generating code based on the design architecture and the identity card parameters corresponding to the resource; determining one or more affected resources in the design architecture affected by the addition of the resource; updating one or more affected identity card parameters of the one or more affected resources; and generating updated code for the one or more affected resources based at least in part on the one or more updated identity card parameters.

Example 16. The method of Examples 14-15, wherein the selection and placement of the resource within the design architecture is performed by a drag and drop operation.

Example 17. The method of Examples 14-16, wherein the user interface is a browser-based application.

Example 18. The method of Examples 14-17, wherein the user interface is a standalone application running on a client device.

Example 19. The method of Examples 14-18, wherein analyzing the provider documentation and provider schema and identifying the one or more resources are performed by a trained machine learning model.

Example 20. The method of Examples 14-19, wherein the trained machine learning model is a large language model.

Example 21. The method of Examples 14-20, wherein the trained machine learning model is a neural network.

Example 22. The method of Examples 14-21, wherein the system is further configured to automatically populate one or more identity card parameters of the resource based at least in part on the identifying the placement of the resource.

Example 23. The method of Examples 14-22, wherein automatically populating the one or more identity card parameters is further based at least in part on analysis by a second trained machine learning model, wherein the second trained machine learning model is trained on a dataset comprising one or more historic design architectures.

Example 24. The method of Examples 14-23, wherein the resource panel is organized into categories and sections.

Example 25. The method of Examples 14-24, wherein one or more of the resources has more than one version and wherein an identity card is generated for each version.

Example 26. The method of Examples 14-25, wherein the system is further configured for: receiving, from the user, a block of edited code; and updating, based on the received block of edited code, the design architecture and identity card parameters of one or more linked resources.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. An infrastructure as code system for creating and managing cloud infrastructure, wherein the system comprising one or more processors configured to perform the operations of:
retrieving, from one or more service providers, provider documentation and one or more provider schema;
analyzing, for each provider, the provider documentation and one or more provider schema;
identifying, based on the analysis, one or more resources from the one or more service providers;
generating, based on the analysis, an identity card for each of the one or more resources wherein the identity card comprises one or more parameters; and
generating, based on the analysis, a resource panel wherein the resource panel comprises one or more resource icons, wherein the one or more resource icons correspond to the one or more resources.

2. The system of claim 1, wherein the one or more processors are further configured to perform the operations of:
generating a user interface comprising a resource panel, a design panel and a code panel;
receiving, from a user, selection of a resource in the resource panel to be added to a design architecture displayed in the design panel and a placement of the resource within the design architecture;
identifying the placement of the resource;
displaying, in the user interface, the identity card corresponding to the added resource;
receiving, from the user, input for each of the one or more identity card parameters, wherein the input comprises text values or selection of a displayed predefined value;
generating code based on the design architecture and the identity card parameters corresponding to the resource;
determining one or more affected resources in the design architecture affected by the addition of the resource;
updating one or more affected identity card parameters of the one or more affected resources; and
generating updated code for the one or more affected resources based at least in part on the one or more updated identity card parameters.

3. The system of claim 2, wherein the selection and placement of the resource within the design architecture is performed by a drag and drop operation.

4. The system of claim 2, wherein the user interface is a browser-based application.

5. The system of claim 2, wherein the user interface is a standalone application running on a client device.

6. The system of claim 2, wherein analyzing the provider documentation and provider schema and identifying the one or more resources are performed by a trained machine learning model.

7. The system of claim 6, wherein the trained machine learning model is a large language model.

8. The system of claim 6, wherein the trained machine learning model is a neural network.

9. The system of claim 6, wherein the system is further configured to automatically populate one or more identity card parameters of the resource based at least in part on the identifying the placement of the resource.

10. The system of claim 9, wherein automatically populating the one or more identity card parameters is further based at least in part on analysis by a second trained machine learning model, wherein the second trained machine learning model is trained on a dataset comprising one or more historic design architectures.

11. The system of claim 2, wherein the resource panel is organized into categories and sections.

12. The system of claim 2, wherein one or more of the resources has more than one version and wherein an identity card is generated for each version.

13. The system of claim 2, wherein the system is further configured for:
receiving, from the user, a block of edited code; and
updating, based on the received block of edited code, the design architecture and identity card parameters of one or more linked resources.

14. A computer-implemented method comprising:
generating a user interface comprising a resource panel, a design panel and a code panel;
retrieving, from one or more service providers, provider documentation and one or more provider schema;
analyzing, for each provider, the provider documentation and one or more provider schema;
identifying, based on the analysis, one or more resources from the one or more service providers;
generating, based on the analysis, an identity card for each of the one or more resources wherein the identity card comprises one or more parameters; and
generating, based on the analysis, the resource panel wherein the resource panel comprises one or more resource icons, wherein the one or more resource icons correspond to the one or more resources.

15. The method of claim 14, wherein the one or more processors are further configured to perform the operations of:
receiving, from a user, selection of a resource in the resource panel to be added to a design architecture displayed in the design panel and a placement of the resource within the design architecture;
identifying the placement of the resource;
displaying, in the user interface, the identity card corresponding to the added resource;
receiving, from the user, input for each of the one or more identity card parameters, wherein the input comprises text values or selection of a displayed predefined value;
generating code based on the design architecture and the identity card parameters corresponding to the resource;
determining one or more affected resources in the design architecture affected by the addition of the resource;
updating one or more affected identity card parameters of the one or more affected resources; and
generating updated code for the one or more affected resources based at least in part on the one or more updated identity card parameters.

16. The method of claim 15, wherein the selection and placement of the resource within the design architecture is performed by a drag and drop operation.

17. The method of claim 15, wherein the user interface is a browser-based application.

18. The method of claim 15, wherein the user interface is a standalone application running on a client device.

19. The method of claim 15, wherein analyzing the provider documentation and provider schema and identifying the one or more resources are performed by a trained machine learning model.

20. The method of claim 19, wherein the trained machine learning model is a large language model.

21. The method of claim 19, wherein the trained machine learning model is a neural network.

22. The method of claim 19, wherein the system is further configured to automatically populate one or more identity card parameters of the resource based at least in part on the identifying the placement of the resource.

23. The method of claim 22, wherein automatically populating the one or more identity card parameters is further based at least in part on analysis by a second trained machine learning model, wherein the second trained machine learning model is trained on a dataset comprising one or more historic design architectures.

24. The method of claim 15, wherein the resource panel is organized into categories and sections.

25. The method of claim 15, wherein one or more of the resources has more than one version and wherein an identity card is generated for each version.

26. The method of claim 15, wherein the system is further configured for:
receiving, from the user, a block of edited code; and
updating, based on the received block of edited code, the design architecture and identity card parameters of one or more linked resources.
